(19) United States
(12) Patent Application Publication
(10) Pub. No.: US 2010/0100439 A1
(43) Pub. Date: Apr. 22, 2010

(54) Multi-platform system apparatus for interoperable, multimedia-accessible and convertible structured and unstructured wikis, wiki user networks, and other user-generated content repositories

(76) Inventors: Dawn Jutla, Halifax (CA); Peter Bodorik, Halifax (CA)

Correspondence Address: Dawn Natalie Jutla, 5531 Blue Willow Court, Halifax, NS, B3H 4H6, CA

(21) Appl. No.: 12/457,494

(22) Filed: Jun. 12, 2009

Related U.S. Application Data
(60) Provisional application No. 61/129,219, filed on Jun. 12, 2008.

(51) Int. Cl. G06F 17/30; G06Q 30/00

(52) U.S. Cl. 705/14.52; 707/741; 707/781; 707/E17.002; 707/E17.005; 707/802

(57) ABSTRACT

The present invention involves allowing users (e.g. an employee, student, professional, expert) to interoperably use multimedia (e.g. text, voice and image gestures) for input and output, including to interface, search, index, edit, add, delete, organize, share, transfer, create, and manage organization(s)' knowledge and information resources within structured wikis, unstructured wikis, and wiki user networks, with extension to other types of user-generated content repositories. The invention makes organizational knowledge and information resources fully accessible by users with different types of interface abilities. The invention proposes a multimedia accessible wild platform-system connecting information and knowledge consumers and producers.

This patent application incorporates, through amendment, the provisional patent application U.S. 61/129,219 entitled “A platform-mediated network, architecture, and systems for interoperable, multimedia-convertible structured and unstructured wikis, wiki user networks, and other user-generated content repositories.”

### BACKGROUND

1. Technical Field

The present invention involves allowing a user (e.g. an employee, student, professional, expert) to interoperably and/or simultaneously use multimedia (e.g. text, voice and image gestures) for input and output, including, to interface, retrieve, search, index, edit, add, delete, organize, reformat, transform, and manage organization(s)' knowledge and information resources within structured wikis, unstructured wikis, wiki user networks, and with extension to other type user-generated content repositories. The invention makes organizational knowledge and information resources fully accessible by users with different types of interface abilities. The invention provides a mediating platform-system connecting information/knowledge producers and consumers.

2. Prior Art

Wikis are valuable to organizations and society as they facilitate user collaboration and knowledge management tasks, such as knowledge creation, knowledge sharing, and knowledge transfer. There are two main types of wikis, in terms of architecture: structured and unstructured. The best-known example of an unstructured wiki is Wikipedia which freely allows any registered user to update material with a high degree of trust in the user's expertise and good intentions. Structured wikis, in contrast, are a combination of wiki and database mechanisms. The database element in structured wilds formally adds a higher degree of access control, and some transactional capability, workflow capability, powerful reporting capability, sophisticated indexing and querying capability, version control, and a subset of features common in the stricter database management systems. Structured wikis were pioneered by Twiki.org.

The state-of-the-art in industry implementations of wild software does not yet support voice- or gesture- or image- or video-based interfaces for structured or unstructured wilds. The population of and retrieval from wikis today are text-and web-browser based. Commonly, entries in wilds are stored in string format. US patent application 20070143692 applies for multiple editable fields in next-generation wiki software while 20070198534 applies for layering multimedia within wikis. Thus we anticipate and assume that next-generation wiki software itself will contain multimedia in future. Further, it is the norm for users to directly populate wiki entries. Our invention proposes that wiki entries may also be automatically populated from data resident in other software applications.

The state-of-the-art in multimedia engines shows that different hosted and/or on-premise servers, engines, or platforms exist for speech processing tasks, such as, speech-to-text, text-to-speech conversions, and language translations (e.g. TellMe networks www.tellme.com, Nuance systems www.nuance.com , Google Translation, IBM Websphere Voice at http://www-306.ibm.com/software/voice/), video management (e.g. YouTube, Joost), image processing servers, and so on. Software platforms separately exist for supporting unstructured (e.g. Wikipedia, Mediawiki) or structured wikis (e.g. Twiki.net). However these different types of hosted or on-premise multimedia engines (e.g. for speech, image, video) and wild platforms have not been (or formerly proposed to be) coupled to create a single, improved and more highly accessible, wiki platform and system than available in the state-of-the-art. Thus multi-modal, multimedia-based user interface access is not a reality in today's wild software or in any public patents or patent applications. Thus, accessibility is limited for users with different interface abilities and limited to certain situations. In addition, today, no bundling of the various multimedia engines (voice, video, gesture-processing, text) exist in implemented form, although individual software and hardware exist for inputting and converting user gestures as software interface actions.

A “wiki” hereafter refers to both structured and unstructured wiki. Further we present the definition for the notion of a platform-mediated network as related art. A platform-mediated network “provides a subset of components and rules employed by users in most of their transactions. Examples of components are hardware, software, and services. Rules are the technical standards, protocols for information exchange, policies, and contracts that govern transactions.” There are one-sided and many-sided platform-mediated network. A many-sided platform-mediated network supports different groups of users. For example, in 2-sided platform-mediated networks, users are primarily members of one distinct group, a “side”, which transacts with a second group, e.g., Job seekers+recruiters. A 3-sided platform-mediated network example is that of Youtube, where the three groups are YouTube's customers: advertisers, viewers, and content providers. Our invention further advances the state-of-the-art, in this area, by providing a non-obvious multimedia accessible platform-based system which connects two or more groups of customers or users—those who primarily produce and those who primarily consume information and knowledge.

### BRIEF SUMMARY OF THE INVENTION

Disclosed is an Interoperable Text, Image, Voice, VideO (ITIVO) Wiki platform system, herein termed ITIVOwiki. The ITIVOwiki platform-mediated network consists of a description of network user groups and the platform system as depicted in FIG. 1. FIG. 2 describes the components of the ITIVOwiki system itself.

Specifically the proposed invention addresses deficiencies in the state-of-the-art with respect to comprehensive multimedia input to and output from wikis, and provides a novel end-to-end platform-system to support at least two different groups of users (wiki consumers and wiki producers) to interface, or search, index, edit, add, delete, organize, share, transfer, create, transform, reformat, and manage multimedia information in wilds. The invention seamlessly provides multimedia input and output capability to and from wilds.

It is a purpose of the invention to allow users to repurpose, repackage, and present information to each other in flexible ways via a wild system. The invention platform-system bundles hardware and software components and services, including services from information transformation engines, along with business logic which aid the users in information manipulation tasks. The platform-system invention accepts a plurality of input media types to generate one or more media type-outputs with application to user-generated content in wilds. However, it is noted that the invention can also be applied to any user-driven collaboration or user-generated content spaces, such as, group or team collaboration, reputation and feedback forums.

In one embodiment of the invention, users select and/or compose services, from multiple types of multimedia processing engines/platforms bundled within the invented platform. Then the user has an option to repackage and reformat the output of the multimedia processing engine(s), using other services, possibly user-composed wiki-services. The user may use a temporary holding storage space for examining and editing his/her wiki input or output before deciding on making changes permanent as an entry in the wiki or delivering the multimedia information to an output recipient. The output recipient may include the user him/herself.

A second aspect of the invention provides unified multimedia profile management to allow users of the invented multimedia service platform to obtain authorization services and personalization services. The user only has to input a single multimedia profile to get the benefit of using multiple multimedia services. The multimedia profile information may be in the form of a user video, user biometric information, image graphics, gestures, and/or audio information. The multimedia profile manager is capable of accepting and managing multiple role-profile data per user. FIG. 3a illustrates the user enrollment with the multimedia profile manager subsystem.

A third aspect of the invention allows a user to temporarily store his/her wiki entry in a holding place, termed a wiki cachepad, so that the user can edit the wiki cachepad entry privately or with other allowed parties, before making the entry permanent to the wiki and viewable to other users.

A fourth aspect of the invention provides software components within a platform to retrieve multimedia information from across a plurality of enterprise software packages, and/or embedded systems, hardware systems, external feeds, internal and external content providers, advertisers, and/or other wikis, and automatically or semi-automatically populate wiki topics in the wiki cachepad.

A fifth aspect of the invention provides a playground system for users to compose their own multimedia platform services and wiki services.

A sixth aspect of the invention provides directory services to manage user-generated wiki services and other wild services.

A seventh aspect of the invention provides plug-ins and integration methods to add multimedia to existing wild products such that the invention automatically or semi-automatically recognizes a change of input/output mode on the wild application such that one or more input channel(s) of possibly different types (text, voice) can be active, as well as, one or more output channels of different types (e.g. text, voice). For example, a user may wish to speak in one task and input text in another task at the same time or at almost simultaneously overlapping times. Thus the invention allows for multiple simultaneous multimedia inputs and outputs to and from wikis.

An eight aspect provides a mechanism to a corporation, which hosts a wiki, to select, limit, or restrict advertising to its employees through the corporate wiki.

A ninth aspect of the invention proposes a non-obvious multimedia accessible wiki-based platform which connects groups of customers of consumer and producer users as shown in FIG. 1.

A tenth aspect of the invention details revenue models for various portions of, as well as, the whole of the platform-system invention.

### DESCRIPTION OF DRAWINGS

FIG. 1 is a block diagram illustrating our proposed wiki-based platform-system comprising two sets of users—consumers and producers. A producing user (e.g. non-expert, expert, domain expert, temp user), 10, produces data and information which may be input, 15, to enterprise and user productivity software applications, 20, or directly, 24, to a multimedia wiki, in 30. 30 represents the wiki-based platform. Of course, data from software applications, internal and external feeds, such as, and not limited to Internet news sources, RSS or ATOM feeds, external publications, scattered multimedia assets (e.g. podcasts, .wav, .jpg, mpeg files etc), or other publications in known or future formats, may also be retrieved from 20, reformatted and filtered by the user, and placed in the multimedia wiki which is incorporated in 30. Generally, the information flow, 25, between 20 and 30 is one source of input/output information which the user can reformat and repackage via the use of the invented platform services. A user, 10, may possibly have also contributed content to the sources listed in the previous sentence i.e. in 20. The information, 25 may be filtered, repackaged, or reformatted, automatically and semi-automatically, with or without the human-in-the-loop. The processed data, 25, may then be used to populate portions of a wild, in 30. Consumers, or users, 40, who use the wiki representation of organization(s)' information will separately retrieve and add data and information, via 35, to the wiki through the platform-system, 30, which allows the user to add or retrieve the information from the resulting wiki, using multimodal multimedia access.

FIG. 2 provides an overview of key components, inputs, and outputs, of the multimedia-accessible wiki platform. N users, 200, each creates one or more user-contextual multimedia profile(s), 230, specifying his or her voice profile, gesture profile (including programmable gestures), and what type of information (e.g. organizational resources or externals ads) the user prefers to receive, e.g., pertaining to his or her goals, job positions, or career paths, or other context. The context information is maintained by the user context manager subsystem, 240. For example, in one context related to her job role, the user would like to be kept informed on what recent updates have been made to the Salesperson training wiki topic, what were the learnings that the attendees of the CRM leadership conference brought back to the company, or when are the next two meetings scheduled for sales strategy discussions. In another example context, in the role of management advisor, the user may want to share knowledge and information regarding recommendations for adoption of certain mobile devices. It is expected that users will create their multimedia profiles once and maintain them after that on occasion but not on every access to the platform.

In the course of normal operations, the user, 200, will issue a service request, 205, via a client-side interface, to the platform. If the user request simply requires a string to be input to the wiki, or require an output available from conventional wikis of today, then the request is passed, via, 215, to the (un)structured wiki service, 350. However, if multimedia accessibility, extraction, transformation, repackaging, reformatting, and/or editing are required, then the user service request is passed via 225, to the multimedia-accessible management (MAM) component system.

The MAM system provides first-level user authorization processes, 221. If user authorization is cleared, the MAM processes the user request further by augmenting the user request with profile knowledge and actions by using 230 and 240. If the augmented user service request contains an extract component, the MAM invokes the appropriate processes/services to extract data, 295, from the user-named sources with source types named in 250 (e.g. ERP, CRM, HCM, PLM, SCM, office applications, etc). The extracted data is then output, along with the rest of the user request, via 305, to the ITIVO interface, 260.

Thus the user can pull information from software packages and other sources, 250, via the ITIVO platform system's connectors in 260, or alternatively information is obtained directly from the user, via 285. This information is input to the interface to the bundled ITIVO multimedia engines along with the user request where an ITIVO service triggers one or more services from the bundled image/gesture-based processing engine(s) or platform, 270, and/or video processing engine(s) or platform, 280, and/or voice processing system(s) or platform, 290, and/or text and web processing engines, 300. Synchronized and/or transformed user output, 375, 385, 395, and/or 405 from the bundled platforms may be output and processed by the business logic, 261, which facilitates the user task identified in 210. The business logic, 261, uses predefined, contracted service level agreements between technology providers and the ITIVO platform-system provider, and/or automatic or semi-automatic functionality matching and quality of service parameters such as time, cost, and reliability, and soft non-functional properties such as scalability, personalization, and security and privacy to determine which services, or combination of services, to consume on the bundled ITIVO platform-system.

The results of the business logic processing, and the augmented user request, trigger the discovery and invocation of appropriate ITIVO web services in directory 310. The web services may include a composition including an ad service. In the background, fraud and auditing services may be separately running. The ITIVO services, 310, invoke the appropriate plug-ins and monitoring services, 320, which support the multimedia (un)structured wiki, 350. The output of the web services 310, can be sent either via 425 to the cachepad, 240, or directly to the wiki, 350.

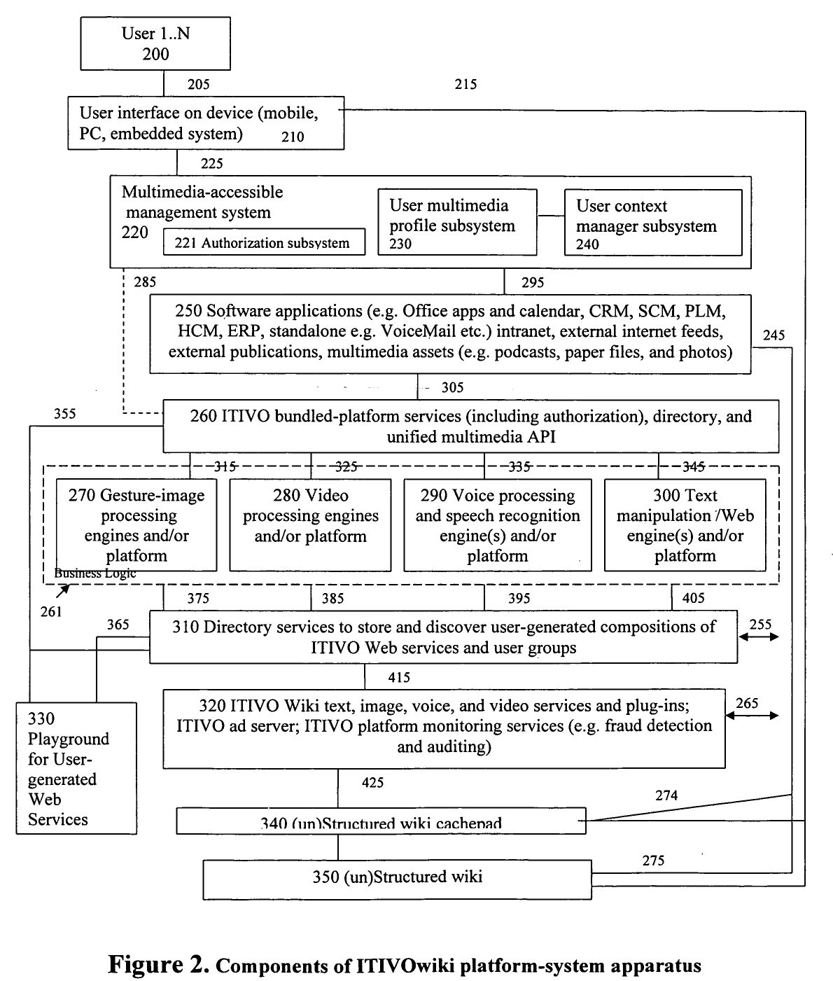

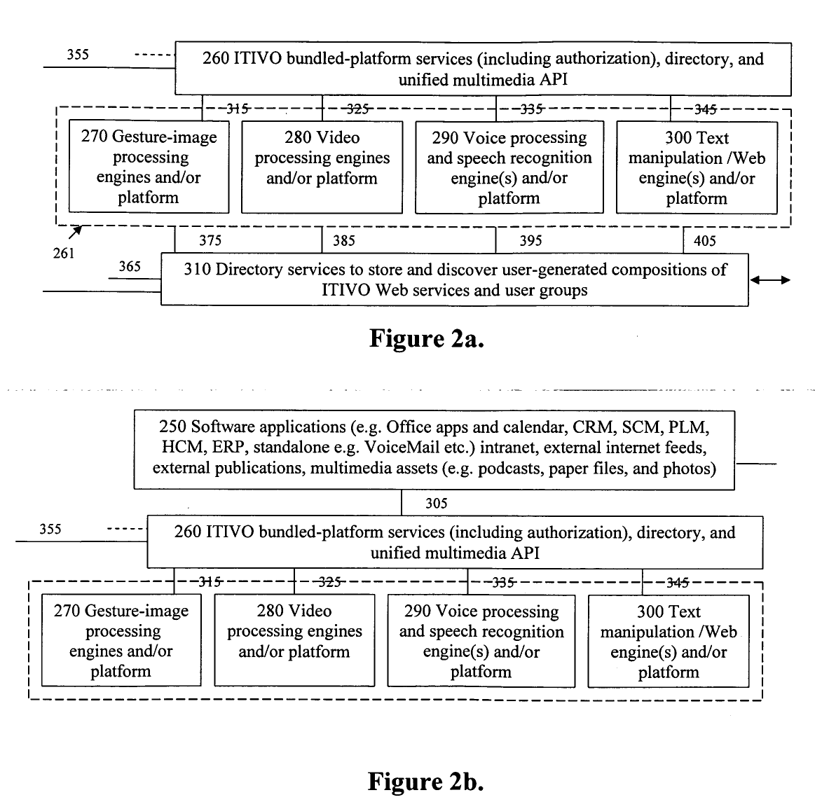

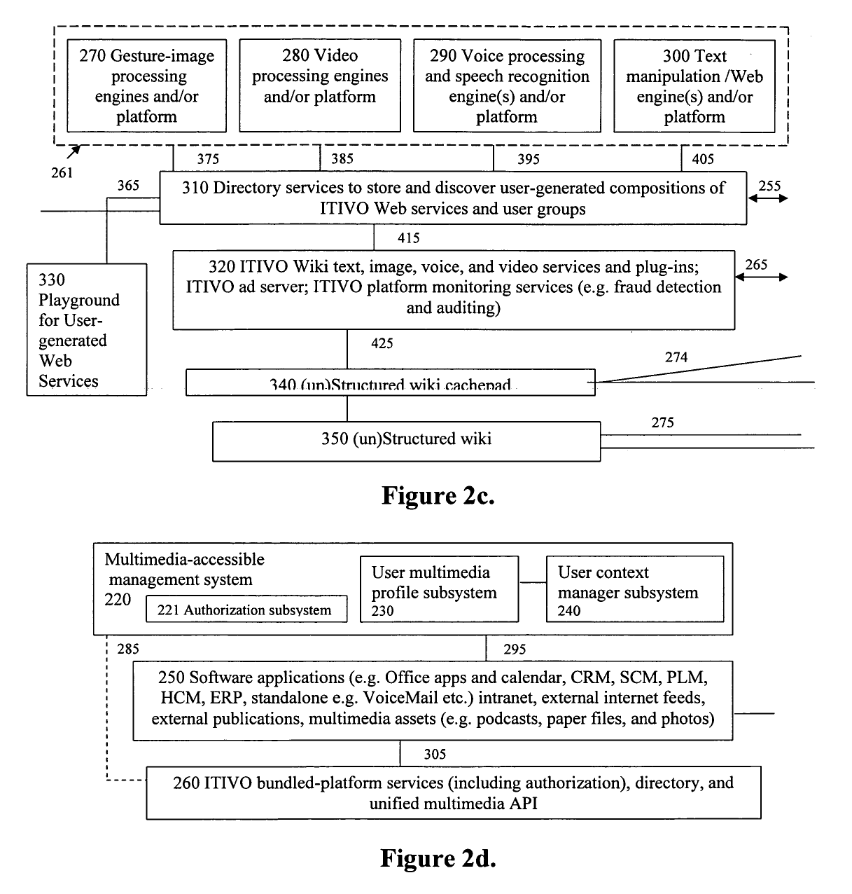

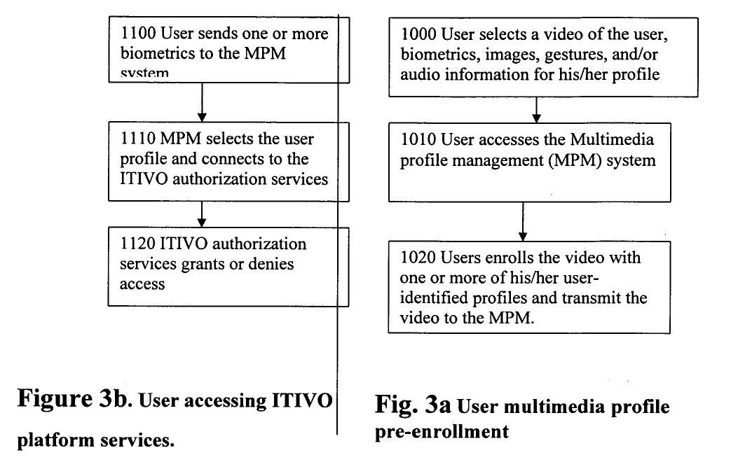

270, 280, 290, and 300 can be bundled platforms, or engines, with two major set of interfacing and integrating services, 260 and 310. This bundling is depicted, in isolation, in FIG. 2a. The bundled engines or platforms, 270, 280, 290 and 300 can be separately on premise, hosted, or combination of on-premise and hosted at different sites. If all the bundled platforms are hosted, then one embodiment will be as partnered platforms. Engines or platforms 270, 280, 290, and 300 may be owned, sponsored, or hosted by different organizations. Our invention integrates and bundles platforms of the types 270, 280, 290, and 300, into one platform-system by providing a common user-level API, 260, and directory service, 310, to all engines, and repositories for user-generated content.

Users may compose and test their own added-value services—user-generated services—in a playground subsystem. Users may then add these services to the ITIVO directories in 260 and 310, depending on the context of the service. New user-composed services are made available to users through the ITIVOwiki platform interface which is downloadable to client devices. It should be noted that the invention thus provides for dynamic addition/deletion of user services, and hence user service requests' types, as users can compose new wiki services or new services from the multimedia engines; mappings are provided between new service compositions and user service requests' types.

In FIG. 2, information, in text, voice, and/or image or video format may be retrieved from the wiki, 340, and output to the multimedia accessible management system before being presented to the user, 200.

FIGS. 2a, 2b, and 2c are subsets of FIG. 2 depicted separately as these subsets of grouped components may have separate revenue models, and these partitioned revenue models are claimed in the invention. FIG. 2a has been described above. FIG. 2b illustrates the ITIVO interface to existing internal and external applications and feeds. FIG. 2c illustrates the ITIVO interface to the wiki application. FIG. 2d illustrates the interface of the multimedia-accessible management system to the ITIVO directory and interface services.

FIGS. 3a shows the user's multimedia profile enrollment process. The user selects a video, audio, image, text, or combination thereof related to him/herself, 1000. S(he) accesses the ITIVOwiki platform-system, specifically the multimedia profile management system, 1010, within the MAM, and uploads her/his multimedia profile to the platform, 1020.

FIG. 3b illustrates the additional role that the user's multimedia profile plays in the platform's authorization services. The user may transmit one or more of her/his biometric information (what the user is), or gesture-based information (what the user does), or information related to what the user knows or what the user owns. The authorization subsystem, 1120, of the MAM works with the profile subsystem, 1110, to decide whether the user is allowed or denied access to one or more of the ITIVOwiki platform services.

### DETAILED DESCRIPTION OF INVENTION

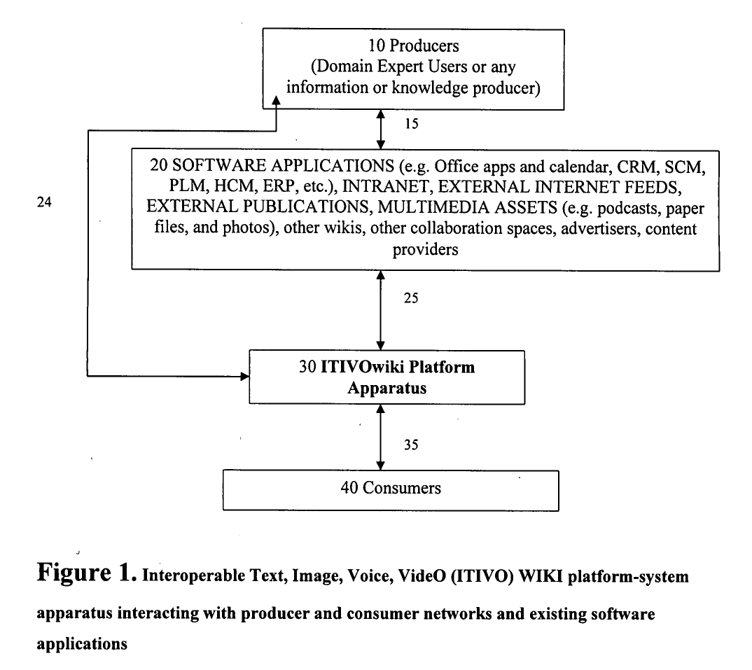

The present invention provides a non-obvious multimedia accessible wild-based platform-system which connects groups of consumer and producer users as shown in the embodiment illustrated in FIG. 1. Note that, although not shown on the FIG. 1, the invention foresees that these consumers and producers groups can be further subdivided and named on each side of the platform.

FIG. 1 illustrates a high-level depiction of information flow from producing users, 10, who store/retrieve information in common applications, 20, such as, and not limited to, office applications, customer relationship management systems, human capital management systems, product development applications, enterprise resource planning applications, supply chain management applications, etc., or store and extract information from external and internal information stores and feeds, such as web sites, blogs, etc. The data in such application systems, 20, may be input or streamed to wikis or structured wikis, 25, or user networks via the proposed invention consisting of the interoperable multimedia-accessibility ITIVOwiki platform. Thus the invention facilitates multimedia data in any known or future format, to be obtained from other systems which domain expert users or ordinary users have previously populated. In turn, data received in the wilds and user networks may also be written back, 25, to applications.

Further, producing users may also create new information and add it directly to the ITIVOwiki platform, 30, as shown in the flow, 24, in FIG. 1. Consuming users, 40, can input and output multimedia data, 35, to the wikis, structured wikis, or user networks via the provided ITIVOwiki platform invention, 30.

The description of FIG. 2, provided above, and the detailed description below are important to the understanding of the invention. The invention provides personal multimedia user profiles, and a multimedia profile manager, in a multimedia profile management subsystem on its platform. A method is provided whereby a user records several sets of multimedia assets (e.g. one or more of user videos, audio, images, biometrics in each set). Users can assign a multimedia set for each profile. The user videos are enrolled as user multimedia profile data for use in various purposes, including and not limited to, wiki authorization mechanisms and personalization mechanisms.

To provide multifactor multimedia-based and biometric user authentication to the next-generation wiki application, the ITIVOwiki platform authorization system, shown as 221 in FIG. 2, will interoperably support a number of authorization methods such as in U.S. Pat. Nos. 6,529,871, 6,735,695, 6,421,453, and US application 20010044906. The system also provides a method for the user to associate his/her gestures with wiki menu actions and/or ITIVOwiki platform actions through a novel usage of methods in US patent application US 20060028429 for interfacing to corporate or community user information.

In one embodiment of the invention, services from many different types of multimedia processing engines are composed to seamlessly provide multimedia input and output capability to the users of wikis. The invention provides an aggregate platform-system consisting of bundling several media platforms together for the purposes of providing a single, integrated, seamless experience to the user for receiving voice- and/or image or gesture-based or video input, or text input, from multiple users from multiple input devices (e.g. mobile, PC microphone, cameras), accessing multimedia-accessible directory services, and producing text-based, image-based, video-based, and voice-based output which can in turn be semi-automatically or automatically input to one or more user-generated wiki(s) and/or output to end-user network devices.

The media platforms or engines participating in the bundle may consist of one or more of a plurality of speech-processing platforms or engines(e.g. services may be transformative e.g. text-to-voice, voice-to-text, or semantic e.g. natural language processing, etc), image or gesture-processing platforms or engines, text processing platforms or engines, web services processing platforms or engines, and video-processing platforms or engines. These platforms or engines may have on premise, or hosted, or a hybrid of on-premise and hosted on-demand delivery models. The bundled resulting platform with its interfaces is depicted in FIG. 2a. Example services from the resulting platform (FIG. 2a) include synchronization of voice, text, and video media as provided in US patent application 20070188657, which may be used in our invention for implementation-specific wiki search and/or wiki content delivery purposes. Other example services are the repackaging of content in a wiki-friendly format.

The invention also provides a single unified, standard API across a host of multimedia engines' services of the same and different types. That is, a plurality of speech, gesture, video, image, or web engines, will serve the user, and other applications, facilitated through a single API.

A further aspect of the invention provides components within a platform-system to retrieve multimedia information from across a plurality of enterprise software packages, embedded systems, and hardware system, or external feeds, and automatically or semi-automatically (with the human-in-the-loop) populate wiki topics. The latter may use methods, such as in U.S. Pat. Nos. 6,104,989 and 6,603,921, for wiki topic identification and indexing of multimedia. This subsystem is depicted in FIG. 2b.

Another aspect of the invention provides a playground subsystem for users to compose their own wiki services. Users will be further provided with systems, built with state-of-the-art software engineering methods, to allow them to drag and drop a number of wiki and multimedia services onto a playground and to evaluate the flow and content of the service execution results. Users can visualize the multimedia-based delivery (U.S. Pat. No. 6,446,130) of the results of their web services compositions while in the playground.

A further aspect of the invention provides methods for multimedia-based directory services to manage user-generated composite services for wikis. Users will be allowed to register user-generated services in the ITIVOwiki directory services.

Another aspect of the invention utilizes plug-ins and integration methods, known to those skilled in the art, to add multimedia to existing wiki products. The system provides a unique voice-plug in to a wiki system which is not known in the state-of the-art. Another novel plug-in, called a “multimode plug-in”, manages the synchronization and integration of user interface modes (e.g. text, voice, image or gesture-based, or video-based) for interfacing to the wild and social network applications. The “multi-mode” plug-in allows a user to switch input or output mode or allow multiple input/output modes to occur on a user demand. The user may use a gesture to control an input/output via a device (US patent application 2006/0028429) to a wiki.

The invention provides plug-ins and integration methods to add multimedia to existing wiki products such that the invention automatically or semi-automatically recognizes a change of input/output mode on the wiki application such that one or more input channel(s) of possibly different types (text, voice) can be active as well as one or more output channels of different types (e.g. text, voice). For example, a user may wish to speak to one task and input text in another task at the same time or almost simultaneously overlapping times. Thus the invention allows for multiple simultaneous multimedia inputs and outputs to and from wikis. A number of multimedia types are captured in a given timeframe. Each multimedia type is processed differently by the multimedia plug-ins and additionally depends on whether the user request is a wiki retrieval or a wiki post.

In the case of wiki post and voice access, a user's voice input is captured from a plurality of user audio-input enabled input devices, (e.g. PC, PDA, iPhone, iTouch, Blackberry, or other mobile device) and a number of alternative methods (e.g. methods in U.S. Pat. No. 6,104,989) may be invoked for deciding under which wiki topic the post will be made. The wiki topic, alternatively, may be user-supplied through a standard IVR type menu hierarchy or voice interface not limited to add, edit, or retrieve options. The user-supplied wiki-topic is sent to a speech recognition engine, either located on the client-side or on a hosted platform. Text for a set of possible wiki-topics is returned to the directory service. The directory service may choose to include the user to confirm the wiki-topic selection, or proceed with its automatic selection of the wiki-topic and/or wiki subtopic. After the wiki-topic selection phase is completed, the ITIVOwiki system will prompt the user for his/her voice input for the wiki. The input is captured and, if requested, is sent to the speech recognition engine for conversion to text. The speech recognition engine outputs the text and sends this via the voice-plug-in to a wiki application.

In the case of a wiki post and gesture-based input, the user gestures are captured and matched, either at client-side or on server or platform system-side, to a user enrolled association between the gesture and keywords which map to wiki (sub)topics. These wiki sub topics may be personal favorites. These personal favorites would have been associated to pre-stored gesture patterns. It is also envisaged for a gesture to be pre-programmed for the user device or wiki application to add wiki input of a particular type at a current active object position.

In the case of a wild post and video-based input being made automatically to the wiki, the video tags may be used to strongly hint at the subtopic, or if tags are absent, then the video can be sent to the speech-processing engine for speech-to-text conversion. The text will then be returned to the multimedia directory service which will then employ frequency-and semantics-based algorithms for eliciting what topic(s) are being spoken on in the video. These topic(s) will then become candidate wiki subtopics to which the video may be posted in the wiki. A human-in-the-loop approach can be employed for confirmation.

Wiki topics may be delivered in a manner similar to an audio book to users via mobile devices. One situation where this delivery may be useful is during user transport. The user can activate cell phones or other PDA (hands-free) with gesture-controlled devices in vehicles (bundling U.S. Pat. Nos. 7,295,904 and 6,236,968) and receive wiki topic information through the cell-phone's audio channel.

Further the platform can support personalized ad services which can be inserted in a user-designated space using for example mechanisms described in U.S. Pat. No. 6,334,109 and U.S. patent application Ser. No. 11/132,840. A mechanism is provided to a corporation, which hosts a wiki, to select, limit, or restrict advertising to its employees through the corporate wiki. The user can customize personalized advertising using methods such as found in U.S. Pat. No. 6,334,109. Fraud detection services such as described in U.S. Pat. No. 5,335,278 and or/U.S. patent application 6,980,972 may also be incorporated.

Revenue models for many-sided platform businesses can be complex as the platforms serve many different groups of customers. The present invention provides a revenue model based on stakeholder type. When the primary wiki users (consumers and producers) are direct employees or employees of partner or supplier firms, the revenue model for the ITIVOwiki platform may be one or more of user subscription-based (preferred), per-use based, and/or to a lesser extent, ad-based. When the primary wild users are customers, citizen, and/or community-based then the primary revenue model for the ITIVOwiki platform is ad-based, although free, low-fee to zero subscription-based revenue models and/or per use revenue models are not excluded for such stakeholders. Thus regardless of stakeholder type, users who otherwise may not have had access to their content, or to obtain multimodal interface ability to multimedia resources, get access and media conversion ability for free or for a subscribed cost where subscription fees costs can be zero or more. There may be differentiated subscription fees depending on whether the user is a producer or consumer.

In addition, the ITIVOwiki platform provider could collect revenues from content providers and commerce providers for media conversion to enable their businesses, or from advertisers, ad providers, and/or ad networks, either through a plurality of methods such as transaction-based revenue sharing, state-of-the-art and future advertising revenue models.

The cost model for the ITIVOwiki platform-system provider would include paying the media system providers within its bundle (as in FIG. 2a), on a license and/or a per use basis, or on a revenue-sharing basis. It is also envisaged that contributing users of novel composed services can revenue share according to ITIVOwiki platform-system policy terms.

Example Uses of the Invention:

Examples are provided below for understanding of the scope and novelty of the patent application. The invention is not limited to just these example situations.

ITIVOwiki platform-systems (ITIVOwikis) can be used in every corporate and government sector and every sector of society. For example, in the university education sector, it is envisaged that students and other stakeholders can use instantiations of an ITIVOwiki or a wiki, which we term a UniWiki system, according to the architecture of FIG. 1, to share multimedia course information. Student producers can input their understanding of course topics, along with multimedia illustrations, and student consumers who are looking at taking the course can understand what the course actually entails. In universities, course descriptions in university calendars are notoriously badly-written and necessarily brief. The UniWiki would enable facets of fact-finding, marketing, knowledge and information management for multiple stakeholders (e.g. student, professor, administrator) with respect to course information. Administrators do not necessarily know how many different perspectives their faculty members bring to a particular subject topic. The Uniwiki would enable them to assess university competency and strength in a particular subject area or aggregation of subject areas. Students can also have multiple and protected sub-wikis within the main Uniwiki for team or group collaboration on assignments using a multiplicity of input and output delivery channels.

ITIVOwiki platform-systems can be used for employee-focused customer care. For example, CRM support centres can use ITIVOwikis to capture employee and customer voice interactions for improved ticket creation and for tracking and monitoring the performance in customer care. Customers form one group of network users, and employees form the other group of network users.

ITIVOwikis can be used in community-focused applications. For example, users with special interest, such as in the film world, form a platform-mediated community on an ITIVOwiki platform. Some members of the community will be primarily consumers and some primarily producers. An ITIVOwiki will enable members to share and communicate with voice as compared to today's passive text/image only-based wikis.

ITIVOwikis can be used to capture and retain corporate memory and ideas during corporate brainstorming meetings or during verbal meeting circles, or storytelling circles. Network groups would be one-sided and comprise collaborating employees.

ITIVOwikis can be used to connect business and consumers where businesses want to manage their brands and consumers want to share their comments about products. For example a platform variation on www.productwiki.com may obtain multimedia accessibility through ITIVO-izing productwiki.

In addition, the invention enables users to forward any information stored in office productivity or communications applications such as in Voicemail, podcasts, wordprocessing, speadsheeting, DB, to the ITIVOwiki.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention and practical applications.

We claim:

1. An apparatus for providing to the user seamless and simultaneous text, image, gesture-based, and/or voice access to manipulate wiki/user repository content, comprising the following:
(1) A coordinating service provider of a multi-platform system for interoperable, multimedia-accessible wild, or user-repository, receiving a client request from a client device to (a) either interface, search, index, retrieve, edit, add, delete, organize, share, transfer, input, and/or manage data, information or knowledge, or (b) compose user wiki/repository services, wherein the request from (a) or (b) includes both an identifier for a user's profile that is necessary for identifying the types of input/output media (voice, text, video, image) required for each action, and authorization information,-and wherein the client request invokes one or more multimedia services from one or more types of multimedia platforms or engines;
(2) The coordinating service provider processing the user request via invoking services from one or more bundled multimedia platforms for voice processing, image-processing, video-processing, and gesture-processing, and outputting zero or more transformed content to appropriate wiki/user repository subsystems, or to the user, depending on the initial client request.
(3) The coordinating service provider invoking zero or more composite user and/or wild services to transform content and store content as specified in the client request.
(4) The coordinating service provider granting the user access to a playground system and wiki cachepad to compose and test zero or more multimedia wiki/repository services to transform and store content, depending on the client request.
(5) The coordinating service provider retrieving multimedia data from zero or more software applications with user authorization, then transforming zero or more of the multimedia data, and triggering a further method for wiki indexing which either places the retrieved data on an existing wild page or on a new wiki page, depending on the client request. The coordinating service provider may retrieve data from the software applications using statistical-based methods (e.g. known and future data retrieval methods from large data sets) for identifying the data to be retrieved or from direct user identification of the data to be retrieved.
(6) The co-ordinating service provider participating in the selection of ads to display to the user via maintenance of individual user profiles.

2. A process and accompanying computer program product in a computer readable medium and/or downloadable medium for providing multimodal multimedia access to manipulate the content of a wild or similar user repository, comprising all or a subset of:
first instructions for the user to interface to a multimedia-accessible profile management subsystem. This subsystem provides first-level user authorization processes. If user authorization is cleared, this subsystem augments the user request with profile knowledge and actions and sends the user request to further subsystems for processing;
second instructions to implement and execute known and future extraction methods for identifying topics for multimedia content obtained from feeds from various multimedia data sources;
third instructions to implement and execute business logic for bundling content transformation services from one or more of a plurality of speech/voice processing, image processing, video processing, text processing, and/or web processing engines or platforms;
fourth instructions to access and execute directory services for user-generated composition of multimedia access services;
fifth instructions to access the playground for users to compose engine or platform wiki/repository services;
sixth instructions to invoke zero or more multimedia wiki plug-ins, and user services;
and seventh instructions for invoking state-of-the-art methods for authorizing, indexing, populating and retrieving multimedia from wilds, and application-level wiki interface services for consuming users.

3. A process and accompanying computer program product in a computer readable medium and/or downloadable medium to effect multimodal-accessible wiki monetization based on selective and rule-based advertising comprising all or a subset of:
first instructions for a multimedia profile manager agent to maintain a mobile directory service on the user's behalf, such that results in the maintenance of a set of preferences and semantic models and/or content regarding the user's favorite wiki topics; privacy and security preferences; user expertise areas; user interest areas; information and knowledge sharing tactics;
second instructions for rule management and preference specification for which subjects subcategories or ads can be pushed to users;
third instructions on receiving a request from the client device, the multimedia management system extracts the user preferences around ad presentation. Ads are then inserted on wiki pages, or via wiki directory services, according to user preferences around topic, frequency of ad appearance, and type of ad display.
